(19) United States
(12) Patent Application Publication
(10) Pub. No.: US 2026/0133366 A1
(43) Pub. Date: May 14, 2026

(54) OPTICAL DEVICE

(71) Applicant: TDK CORPORATION, Tokyo (JP)

(72) Inventors: Hiroshi TAKE, Hong Kong (CN); Cheng Bu HENG, Hong Kong (CN); Tetsuya MINO, Hong Kong (CN); Taku KOSUGE, Hong Kong (CN)

(73) Assignee: TDK CORPORATION, Tokyo (JP)

(21) Appl. No.: 19/359,326

(22) Filed: Oct. 15, 2025

(30) Foreign Application Priority Data
Oct. 21, 2024 (JP) 2024-184917

(51) Int. Cl. G02B 6/122; G02B 6/12

(52) U.S. Cl. CPC G02B 6/122; G02B 2006/12038; G02B 2006/1204; G02B 2006/12097

(57) ABSTRACT

The optical device includes a substrate, a waveguide layer having a slab portion that is provided in contact with the substrate and a ridge portion that is provided to protrude from the slab portion, a buffer layer that is provided so as to cover the waveguide layer and contains, as a principal component, SiO₂ having a refractive index adjusted to be not less than 1.2 and less than 1.4, and a protection layer that is provided so as to cover the buffer layer and suppress a change in the refracting index of the buffer layer.

### CROSS REFERENCE TO RELATED APPLICATION

This application claims the benefit of Japanese Priority Patent Application No. 2024-184917 filed on Oct. 21, 2024, the entire contents of which are incorporated herein by reference.

### FIELD

The present disclosure relates to an optical device.

### BACKGROUND

As optical devices in which optical waveguides are provided on substrates, an optical modulation device that converts an electric signal into an optical signal, a coupler device that mixes RGB laser beams incident thereon to emit a mixed laser beam, and the like are known. An optical waveguide that is provided in such an optical device has a partially curved path in many cases in response to a demand to fit a long path in a small chip (see, e.g., Japanese Translation of PCT Application No. 2023-522151).

### SUMMARY

In a case where a path having a curved portion formed by being folded back is to be employed as an optical waveguide, if a radius of curvature of the curved portion is reduced, space efficiency is increased. However, in a case of a typical optical device in which, e.g., a waveguide layer is formed of lithium niobate (LN) having a refractive index of 2.2 and covered with a protection layer made of silicon dioxide (SiO₂) having a refract index of 1.5, when a light beam traveling along the optical waveguide is incident at an angle of incidence of less than about 42° with respect to a boundary surface, the light beam leaks out toward the protection layer. In other words, as a length of the optical waveguide is increased or the radius of curvature of the curved portion is reduced, a propagation loss of the light beam is increased accordingly.

The present disclosure has been made in order to solve such a problem, and provides an optical device that can suppress a propagation loss of a traveling light beam even when a length of an optical waveguide is increased or a radius of curvature of a curved portion of a path is reduced.

An optical device in an aspect of the present disclosure includes: a substrate; a waveguide layer having a slab portion that is provided in contact with the substrate and a ridge portion that is provided to protrude from the slab portion; a buffer layer that is provided so as to cover the waveguide layer and contains, as a principal component, SiO₂ having a refractive index adjusted to be not less than 1.2 and less than 1.4; and a protection layer that is provided so as to cover the buffer layer and suppress a change in the refracting index of the buffer layer.

It may be possible that, in the optical device described above, the protection layer is configured to be made of a translucent material having a refractive index larger than the refractive index of the buffer layer. It may also be possible that the protection layer has a thickness of not less than 500 nm. In that case, it may be possible that the buffer layer has a thickness of not less than 10 nm and less than 300 nm.

It may be appropriate that the waveguide layer in the optical device described above contains lithium niobate as a principal component. It may also be appropriate that, in the optical device described above, an angle formed by a sidewall of the ridge portion with respect to a reference surface of the substrate is not less than 70° and not more than 90°. It may be possible that the slab portion has a thickness decreasing gradually with an increasing distance from a position where the slab portion crosses a sidewall of the ridge portion. It may also be possible that the SiO₂ of the buffer layer contains a Si-H group. It may be appropriate that the protection layer contains any of materials which are a M—Si—O material (M is at least one or more of Al, Zr, Hf, La, Ba, Bi, Ti, Ca, Mo, and In), SiN, SiON, and SiO₂ having a refractive index of not less than 1.5. It may also be possible that the buffer layer and the protection layer in the optical device described above are provided in a region corresponding to a curved path formed of the ridge portion.

According to the present disclosure, it is possible to provide an optical device that can suppress a propagation loss of a traveling light beam even when a length of an optical waveguide is increased or a radius of curvature of a curved portion of a path is reduced.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the technology.

FIG. 1 is a diagram illustrating an overall configuration of an optical modulation device as an embodiment of an optical device;

FIG. 2 is a diagram illustrating a configuration of an optical modulation element to be used in the optical modulation device;

FIG. 3 is a III-III cross-sectional view of a laminated plate;

FIG. 4 is a diagram schematically illustrating a configuration of a plasma CVD device forming a buffer layer; and

FIG. 5 is a cross-sectional view of the laminated plate having a waveguide layer according to a modification.

### DETAILED DESCRIPTION

In the following, some example embodiments and modification examples of the technology are described in detail with reference to the accompanying drawings. Note that the following description is directed to illustrative examples of the disclosure and not to be construed as limiting the technology. Factors including, without limitation, numerical values, shapes, materials, components, positions of the components, and how the components are coupled to each other are illustrative only and not to be construed as limiting the technology. Further, elements in the following example embodiments which are not recited in a most-generic independent claim of the disclosure are optional and may be provided on an as-needed basis. The drawings are schematic and are not intended to be drawn to scale. Like elements are denoted with the same reference numerals to avoid redundant descriptions.

Referring to the accompanying drawings, a description will be given of embodiments of the present disclosure. In each of the drawings, components denoted by the same reference signs have the same or similar configurations. When there are a plurality of structures having the same or similar configurations in the individual drawings, to avoid complication, some of the structures may be denoted by the same reference signs and others may not be denoted by the same reference signs. Note that it is not intended to limit the disclosure according to the claims to the following embodiments. In addition, not all the configurations described in the embodiments are essential as means for solving the problems.

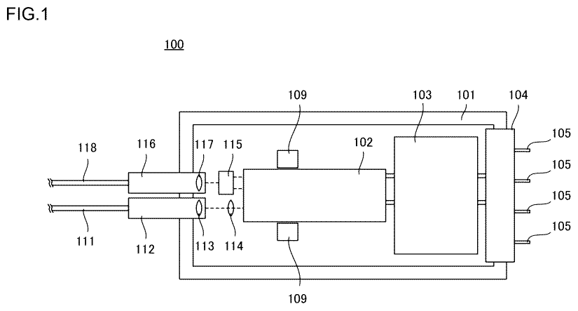

FIG. 1 is a diagram illustrating an overall configuration of an optical modulation device 100 as an embodiment of an optical device. The optical modulation device 100 may be configured to include a package 101 in which an optical modulation element 102 and a relay substrate 103 are hermetically sealed. The optical modulation element 102 is, e.g., a DP-QPSK modulator.

The optical modulation device 100 may have a plurality of signal pins 105 for inputting a high-frequency electric signal to be used for modulation by the optical modulation element 102 and a field-through portion 104 for introducing these signal pins 105 into the package 101. The optical modulation device 100 also may have, in the same side surface of the package 101, an input optical fiber 111 for inputting a light beam into the package 101 and an output optical fiber 118 for guiding the light beam modulated by the optical modulation element 102 to the outside of the package 101.

The input optical fiber 111 and the output optical fiber 118 may be fixed to the package 101 via respective supports 112 and 116 serving as fixing members. The light beam input from the input optical fiber 111 is collimated by a lens 113 disposed in the support 112 and then input to the optical modulation element 102 via a lens 114. Note that it may also be possible to connect an end surface of the input optical fiber 111 directly to an input portion of an optical waveguide described later without the lens.

The optical modulation device 100 also may have an optical unit 115 that polymerization-combines two modulated light beams output from the optical modulation element 102. A light beam output after the polymerization combination from the optical unit 115 is focused by a lens 117 disposed in the support 116 to be derived into the output optical fiber 118.

The relay substrate 103 may relay the high-frequency electric signal input from the signal pins 105 to the optical modulation element 102 by using a conductor pattern not shown. The conductor pattern is connected by, e.g., wire bonding to one end of a signal electrode of the optical modulation element 102. The optical modulation device 100 also includes a plurality of terminators 109 each having a predetermined impedance in the package 101.

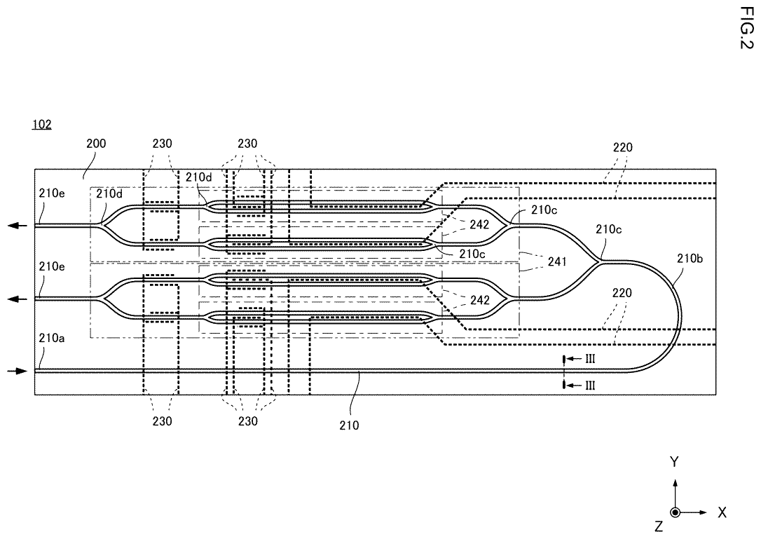

FIG. 2 is a diagram illustrating a configuration of the optical modulation element 102 to be used in the optical modulation device 100. The optical modulation element 102 has an optical waveguide 210 formed as a portion of a laminated plate 200 and performs, e.g., DP-QPSK modulation at 200 gigabits (200 G) per second. A laminated structure of the laminated plate 200 will be described later in detail, and the optical waveguide 210 is a ridge portion that is provided to protrude into a waveguide layer that may be included in the laminated plate 200 and formed as a path for guiding the light beam onto a planar surface of the laminated plate 200.

In the present embodiment, the laminated plate 200 is formed in a rectangular shape. As illustrated in the drawings, it is determined that a long-side direction is an X-axis direction, a short-side direction is a Y-axis direction, and a thickness direction is a Z-axis direction. Note that, in the following drawings also, the same coordinate axes are additionally shown to indicate an orientation of the laminated plate 200.

The optical waveguide 210 has, at one short side of the laminated plate 200, an input portion 210a that receives an input light beam from the input optical fiber 111. Then, the optical waveguide 210 extends in the X-axis direction and passes through a semi-circular curved portion 210b, where a direction of travel is changed by 180°, to reach a branched portion 210c. The branched portion 210c is provided in three stages, and the one optical waveguide 210 is branched into eight branches.

The optical waveguide 210 branched to the eight branches form Mach-Zehnder optical waveguides 242 (portions surrounded by dash-dot lines) in each of which two parallel waveguides adjacent to each other form a pair and further form nested Mach-Zehnder optical waveguides 241 (portions surrounded by two-dot-dash lines) in each of which two of the Mach-Zehnder optical waveguides 242 adjacent to each other form a pair. Each of the nested Mach-Zehnder optical waveguides 241 performs QPSK modulation on each of the branched input light beams, and then combines the light beams after the modulation with each other at a junction portion 210d. The light beams output from the two nested Mach-Zehnder optical waveguides 241 are respectively output from two output portions 210e that are provided at the same short side of the laminated plate 200, similarly to the input portions 210a. The respective light beams output from the two output portions 210e are polymerization-combined together by the optical unit 115 to be merged into one optical beam.

The laminated plate 200 is provided with signal electrodes 220 for causing the four respective Mach-Zehnder optical waveguides 242 included in the nested Mach-Zehnder optical waveguides 241 to perform modulating operations. The signal electrodes 220 have respective one ends connected to individual output terminals of the relay substrate 103. The signal electrodes 220 have respective other ends connected to terminators 109. Consequently, the high-frequency electric signal input from the relay substrate 103 propagates as a traveling wave through the signal electrodes 220 to modulate the light beams propagating through the respective Mach-Zehnder optical waveguides 242.

Meanwhile, the optical modulation element 102 is provided with a plurality of bias electrodes 230 for compensating for bias point fluctuations due to DC drift. To each of the bias electrodes 230, a direct-current or low-frequency electric signal is applied to compensate for the bias point fluctuations in the Mach-Zehnder optical waveguides 242.

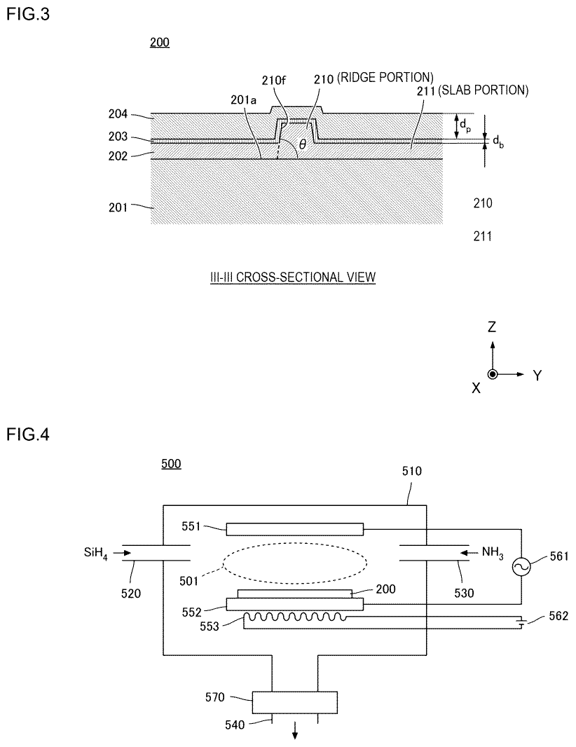

FIG. 3 is a III-III cross-sectional view of the laminated plate 200 illustrated in FIG. 2. The laminated plate 200 may be configured to include a substrate 201, a waveguide layer 202 laminated on the substrate 201, a buffer layer 203 laminated on the waveguide layer 202, and a protection layer 204 laminated on the buffer layer 203. In addition, there are also portions on which the signal electrodes 220 and the bias electrodes 230 are laminated as described above, though not shown in a III-III cross section.

As the substrate 201, e.g., a Si substrate or a sapphire substrate is used. The waveguide layer 202 has a slab portion 211 that is provided in contact with the substrate 201 and a ridge portion that is provided to protrude in a convex shape from the slab portion 211 and may function as the optical waveguide 210. The waveguide layer 202 is formed of a lithium niobate film containing, as a principal component, a lithium niobate having a high refractive index (LN: refractive index of 2.2) compared to that of another material. A portion of the waveguide layer 202 is partially removed by etching treatment or the like, and a region thereof protected by a mask remains as the ridge portion.

In the ridge portion thus formed, an angle θ formed by a sidewall 210f thereof with respect to a reference surface 201a (XY-plane) corresponding to a surface of the substrate 201 may be not less than 70° and not more than 90°. When the formed angle θ is in such a range, it is easy to laminate the buffer layer 203 on the waveguide layer 202.

The buffer layer 203 is a thin film containing, as a principal component, SiO₂ having a refractive index adjusted to be not less than 1.2 and less than 1.4 and formed so as to cover an upper surface of the waveguide layer 202, though a specific film deposition method therefor will be described later. A thickness d_{b} of the buffer layer 203 is adjusted to be not less than 10 nm and less than 300 nm. By providing the buffer layer 203 thus configured in superimposed relation on the waveguide layer 202, the light beam traveling along the optical waveguide 210 is totally reflected unless the traveling light beam is at an angle of less than about 36° with respect to a boundary surface between the waveguide layer 202 and the buffer layer 203 (when the refractive index of the buffer layer 203 is 1.3), and, therefore, with this a propagation loss can be suppressed more effectively than with the conventional buffer layer 203. This allows the optical waveguide 210 longer than conventionally to be designed. In addition, when propagation loss tolerance is set in a given range, the radius of curvature of the curved portion 210b can be reduced to be smaller than conventionally to improve design flexibility of the laminated plate 200.

Meanwhile, SiO₂ having the refractive index adjusted to be not less than 1.2 and less than 1.4 is easily altered over time by being exposed to atmospheric air, and the refractive index thereof also increases to a typical refractive index of about 1.5. Accordingly, in the present embodiment, the protection layer 204 is further laminated so as to cover an upper surface of the buffer layer 203. The protection layer 204 is formed of a material that suppresses a change in the refractive index of the buffer layer 203, and the present embodiment uses any one of materials which are a M—Si—O material (M is at least one or more of Al, Zr, Hf, La, Ba, Bi, Ti, Ca, Mo, and In), SiN, SiON, and SiO₂ having a refractive index of not less than 1.5. Such a configuration allows the buffer layer having a refractive index smaller than that of a conventional material to be implemented.

Alternatively, the material of the protection layer 204 may also be a light-absorbing material that absorbs light. When the light-absorbing material is used for the protection layer 204, it is possible to absorb the light beam leaking out of the optical waveguide 210 through the buffer layer 203 and further into the protection layer 204, which contributes to prevention of stray light. Still alternatively, the material of the protection layer 204 may also be a translucent material having a refractive index larger than the refractive index of the buffer layer 203. By adopting the translucent material having the refractive index larger than the refractive index of the buffer layer 203 for the protection layer 204, it is possible to significantly reduce the light beam leaking out of the optical waveguide 210 through the buffer layer 203 and travelling further into the protection layer 204, and reflected by a boundary surface of the protection layer 204, and then returning to the buffer layer 203 and the optical waveguide 210, and thereby destabilizing the light beam passing through the optical waveguide 210. For example, SiN, LaSiO₂, and SiO₂ having the refractive index of not less than 1.5 correspond to the translucent material having the refractive index larger than the refractive index of the buffer layer 203.

From the viewpoint of protecting the buffer layer 203, the protection layer 204 may have a thickness dₚ larger than the thickness d_{b} of the buffer layer 203 and, specifically, the thickness dₚ may be not less than 500 nm. Note that the signal electrodes 220 and the bias electrodes 230 each described above are provided in superimposed relation on an upper surface of the protection layer 204.

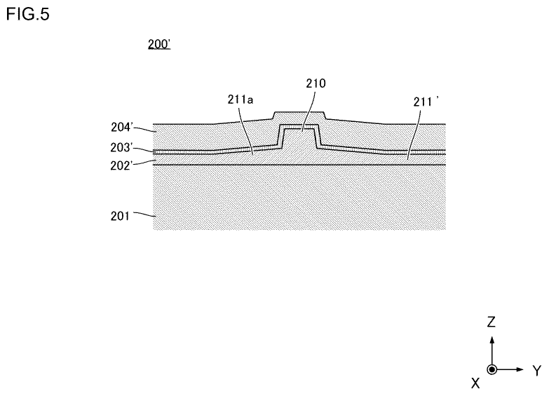

FIG. 4 is a diagram schematically illustrating a configuration of a plasma CVD device 500 forming the buffer layer 203. The plasma CVD device 500 may include a chamber 510, an upper electrode 551, a lower electrode 552, a heater 553, a high-frequency power source 561, a direct-current power source 562, and an exhaust device 570.

The laminated plate 200 before formation of the buffer layer 203 is disposed on the lower electrode 552 and heated by the heater 553 energized by the direct-current power source 562. The chamber 510 is internally evacuated through an exhaust pipe 540 by using the exhaust device 570. Subsequently, an Ar gas is supplied from a first supply pipe 520 into the chamber 510 to generate a plasma 501 between the upper electrode 551 and the lower electrode 552 to which power is applied from the high-frequency power source 561. Then, a reactive gas containing SiH₄ and a reactive gas containing NH₃ are respectively supplied from the first supply pipe 520 and a second supply pipe 530 into the chamber 510 to deposit the buffer layer 203 containing, as a principal component, a SiO₂ layer containing a Si—H group and having a refractive index of not less than 1.2 and less than 1.4 on the waveguide layer 202 of the laminated plate 200. Thereafter, annealing treatment is performed to remove a residual stress.

Note that the present embodiment has described an example in which the buffer layer 203 is deposited using the plasma CVD device 500, but a method of forming the buffer layer 203 is not limited thereto. The buffer layer 203 can also be formed by using a method such as atmospheric pressure CVD or thermal CVD.

While the laminated plate 200 according to the present embodiment has been described heretofore, a configuration of the laminated plate 200 can variously be changed. For example, in the example described above, an upper surface of the slab portion 211 included in the waveguide layer 202 is formed to be parallel to the reference surface 201a (XY-plane) of the substrate 201, but may also be inclined. FIG. 5 is a cross-sectional view of a laminated plate 200′ having a waveguide layer 202′ according to a modification, which corresponds to a line III-III in FIG. 2.

As illustrated in the drawing, in the waveguide layer 202′, a cross-sectional shape of the optical waveguide 210 serving as the ridge portion is the same as in the waveguide layer 202 described above, but a slab portion 211′ is configured such that a thickness thereof decreases gradually with an increasing distance from a position where the slab portion 211′ crosses a sidewall of the ridge portion. In other words, an elevated portion 211a is formed around the ridge portion. Such a configuration can suppress a propagation loss even for the light beam traveling from the optical waveguide 210 to the slab portion 211′ in a cross section of a light flux.

In addition, the foregoing laminated plate 200 has a configuration in which the entire waveguide layer 202 is covered with the buffer layer 203, while the entire buffer layer 203 is covered with the protection layer 204, but the laminated plate 200 may also be configured such that only a region of the optical waveguide 210 corresponding to a curved path, such as the semi-circular curved portion 210b, is covered with the buffer layer and the protection layer. Such a configuration can also suppress the loss in the curved portion in which the propagation loss particularly tends to increase.

While the optical modulation device 100 according to the present embodiment has been described heretofore, an optical device including a substrate, a waveguide layer, a buffer layer, and a protection layer as described above is not limited to the optical modulation device, and can variously be applied. For example, the optical device can also be applied to an optical mixing device for projectors that receives RGB laser beams having adjusted outputs and incident thereon, mixes the RGB laser beams along the optical waveguide, and outputs a light beam in any color or the like.

1. An optical device comprising:
a substrate;
a waveguide layer having a slab portion that is provided in contact with the substrate and a ridge portion that is provided to protrude from the slab portion;
a buffer layer that is provided so as to cover the waveguide layer and contains, as a principal component, SiO₂ having a refractive index adjusted to be not less than 1.2 and less than 1.4; and
a protection layer that is provided so as to cover the buffer layer and suppress a change in the refracting index of the buffer layer.

2. The optical device according to claim 1, wherein the protection layer is made of a translucent material having a refractive index larger than the refractive index of the buffer layer.

3. The optical device according to claim 1, wherein the protection layer has a thickness of not less than 500 nm.

4. The optical device according to claim 3, wherein the buffer layer has a thickness of not less than 10 nm and less than 300 nm.

5. The optical device according to claim 1, wherein the waveguide layer contains lithium niobate as a principal component.

6. The optical device according to claim 1, wherein an angle formed by a sidewall of the ridge portion with respect to a reference surface of the substrate is not less than 70° and not more than 90°.

7. The optical device according to claim 1, wherein the slab portion has a thickness decreasing gradually with an increasing distance from a position where the slab portion crosses a sidewall of the ridge portion.

8. The optical device according to claim 1, wherein the SiO₂ of the buffer layer contains a Si—H group.

9. The optical device according to claim 1, wherein the protection layer contains any of materials which are a M—Si—O material (M is at least one or more of Al, Zr, Hf, La, Ba, Bi, Ti, Ca, Mo, and In), SiN, SiON, and SiO₂ having a refractive index of not less than 1.5.

10. The optical device according to claim 1, wherein the buffer layer and the protection layer are provided in a region corresponding to a curved path formed of the ridge portion.
